(19) United States
(12) Patent Application Publication
(10) Pub. No.: US 2009/0032182 A1
(43) Pub. Date: Feb. 5, 2009

(54) DEVICE AND METHOD FOR PRODUCING A TEST ADHESIVE STRIP ROLL FOR VISUALIZING AIR CURRENTS

(75) Inventors: Eva-Maria MENDEZ MONTILLA, Bremen (DE); Michael Reiners, Bremen (DE); Christopher Sander, Seevetal (DE)

Correspondence Address: INGRASSIA FISHER & LORENZ, P.C., 7010 E. COCHISE ROAD, SCOTTSDALE, AZ, 85253, US

(73) Assignee: AIRBUS DEUTSCHLAND GMBH, Hamburg (DE)

(21) Appl. No.: 12/253,028

(22) Filed: Oct. 16, 2008

Related U.S. Application Data
(63) Continuation of application No. PCT/EP2007/003130, filed on Apr. 5, 2007.

(51) Int. Cl. B32B 38/00

(52) U.S. Cl. 156/256; 156/519

(57) ABSTRACT

A device for producing a test adhesive strip roll, on which a test adhesive strip is wound, containing a thread access unit having a thread roll, on which a thread is wound; a thread cutting unit, which cuts a thread supplied by the thread access unit from the thread roll into the thread pieces having a predetermined length; an adhesive strip unrolling unit, which guides an adhesive strip; an assembly unit, which applies the thread pieces at a predetermined angle and a predetermined distance to one another to the surface of the supplied adhesive strip, so that a free end of a thread piece projects away from the edge of the adhesive strip; an unrolling unit, which unrolls a cover strip onto the surface of the adhesive strip and the thread pieces applied thereto to form the test adhesive strip, containing the adhesive strip, the cover strip, and the interposed thread pieces; and a rolling device, on which the test adhesive strip is rolled up.

### CROSS-REFERENCE TO RELATED APPLICATION

This application is a continuation of International Application No. PCT/EP2007/003130, filed Apr. 5, 2007, which was published under PCT Article 21(2) and which claims priority to German Patent Application No. 102006018133.6 filed Apr. 19, 2006 and of U.S. Provisional Patent Application No. 60/745,097 filed Apr. 19, 2006, the disclosure of which applications is hereby incorporated herein by reference.

### TECHNICAL FIELD

The present invention relates to a device and a method for producing a test adhesive strip roll, on which a test adhesive strip is wound, on whose surface multiple thread pieces are implemented, which project beyond an edge of the test adhesive strip. A test adhesive strip wound on a test adhesive strip roll of this type may be used in particular for visualizing air currents on surfaces of a model to be tested.

### BACKGROUND

There are various possibilities for visualizing air currents on model surfaces in wind tunnels. One technique is the use of threads on the surface which is to be examined. The behavior of the threads provides a rapid overview of the air current conditions in the region examined. By illumination with UV light, white threads or threads made of fluorescent synthetic material are very well visible, so that these measurements may be documented using a video camera. The threads are typically glued onto the model surface, either in sequence using adhesive material droplets or using adhesive strip pieces, or they are stuck onto one side of an adhesive strip before the adhesive strip is attached to the model. In high-velocity areas, for example, the technique in which the threads are attached individually is used, because adhesive strips may not interfere with the surface of the model. In lower-velocity areas, however, preconfigured adhesive strips having threads may be used. The adhesive strips having the threads are cut to length by hand, which is time-consuming and cumbersome.

In view of the foregoing, there may be a need to produce a possibility for providing threads for visualizing air currents, in such a way that they may be used rapidly and efficiently in the visualization of air currents on surfaces of a model. In addition, other need, desirable features and characteristics will become apparent from the subsequent summary and detailed description and the appended claims, taken in conjunction with the accompanying drawings and this background.

### SUMMARY

The device according to an embodiment of the present invention for producing a test adhesive strip roll, on which a test adhesive strip is wound in one piece, on whose surface multiple thread pieces are implemented, contains a thread access unit having a thread roll, on which a thread is wound in one piece, a thread cutting unit, which cuts a thread supplied by the thread access unit from the thread roll into the thread pieces at a predetermined length, an adhesive strip unrolling unit, which supplies an adhesive strip, an assembly unit, which applies the thread pieces to the surface of the supplied adhesive strip at a predetermined angle and a predetermined distance from one another, so that a free end of each thread piece projects away from the edge of the adhesive strip, an unrolling unit, which unrolls a cover strip onto the surface of the adhesive strip and the thread pieces applied thereto to form a test adhesive strip, which comprises the adhesive strip, the cover strip, and the interposed thread pieces, and a rolling unit, on which the test adhesive strip is rolled up.

The distance of the thread pieces to one another may always be constant. The thread pieces may be located perpendicular to the longitudinal direction of the adhesive strip on a surface thereof and extend beyond the edge of the adhesive strip.

According to an embodiment of the present invention, the cover strip is a foam film. According to another embodiment, the cover strip is easily removable from the test adhesive strip, without the thread pieces being damaged and/or detached from the adhesive strip.

The method according to an embodiment of the present invention for producing the above-mentioned test adhesive strip roll has the following steps: supplying a thread, which is wound on a thread roll, by a thread access unit, cutting the supplied thread into thread pieces of a predetermined length by a thread cutting unit, supplying an adhesive strip by an adhesive strip unrolling unit, applying the cut thread pieces at a predetermined angle and a predetermined distance from one another to the surface of the adhesive strip by an assembly unit, unrolling a cover strip onto the surface of the adhesive strip and the thread pieces attached thereto, in order to form the test adhesive strip, which contains the adhesive strip, the cover strip, and the interposed thread pieces, and rolling up the test adhesive strip on a rolling device, such as a spool.

According to an embodiment of the present invention, the individual steps are performed automatically, so that the test adhesive strips may be produced and wound up on the rolling device continuously.

A test adhesive strip produced by the method described above and/or the device described above may be used for visualizing air currents on surfaces by unrolling the test adhesive strip rolled up on the rolling unit, removing the cover strip, and sticking the test adhesive strip having the threads to the surface on which the air currents are to be visualized.

### BRIEF DESCRIPTION OF THE DRAWINGS

The present invention will hereinafter be described in conjunction with the following drawing figures, wherein like numerals denote like elements, and

FIG. 1 shows a schematic partial view of a device for producing the test adhesive strip according to the preferred exemplary embodiment from the side;

FIG. 1a shows a schematic view to illustrate the movement capability of a robot unit shown in FIG. 1;

FIG. 2a-2c show a side, front, and top view of a thread access unit and a thread cutting unit from FIG. 1;

FIG. 3 shows a side view of pincers for gripping and holding a thread;

FIG. 3a shows an interior view of the left pincer leg;

FIG. 3b shows an interior view of the right pincer leg;

FIG. 4 shows a side view of the thread cutting unit from FIG. 1;

FIG. 4a shows a top view of the thread cutting unit from FIG. 1;

FIG. 5 shows a schematic configuration of the device from FIG. 1 from the front;

FIG. 6 shows an assembly unit having the pincers shown in FIG. 3;

FIG. 7 shows a partial view of a model having an adhesive strip having threads;

FIG. 8 shows a partial view of a mounting plate of the working area of the device from FIG. 1;

FIG. 9 shows a partial view of a base frame of the device from FIG. 1 from the front;

FIG. 10 shows a gripper of the assembly unit shown in FIG. 6;

FIG. 11 shows a rolling device for a test adhesive strip;

FIG. 12 shows a partial view of the working area of the device from FIG. 1;

FIG. 13 shows a more detailed view of the rolling unit shown in FIG. 12; and

FIG. 14 shows a partial view of the device according to the preferred exemplary embodiment, which illustrates the cover strip unrolling unit.

### DETAILED DESCRIPTION

The following detailed description is merely exemplary in nature and is not intended to limit the invention or the application and uses of the invention. Furthermore, there is no intention to be bound by any theory presented in the preceding background and summary or the following detailed description.

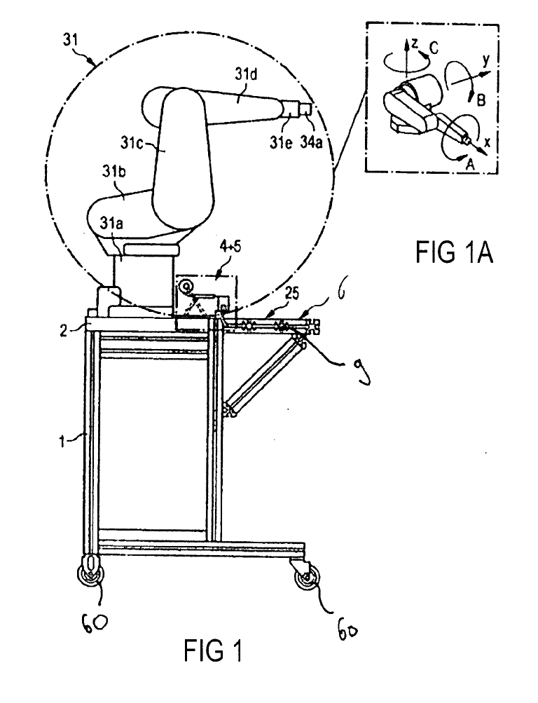

FIG. 1 shows a partial view of a first exemplary embodiment of a device according to and embodiment the present invention. The device, as it is described in the following, is designed to glue thread pieces automatically to adhesive strips and to apply a cover film thereto to form a test adhesive strip, which is wound up automatically on a test adhesive strip roll.

As shown in FIG. 1, the device contains a stand 1, on which a stand plate 2 is mounted. A robot unit 31 is mounted on the stand plate 2. The robot unit contains a robot base stand 31a, which is mounted fixed on a surface of the stand plate 2, a robot turntable 31b, a robot rocker 31c, a robot arm 31d, a robot hand 31e, and a robot flange 34a. The individual movement directions of the robot elements are illustrated in FIG. 1a.

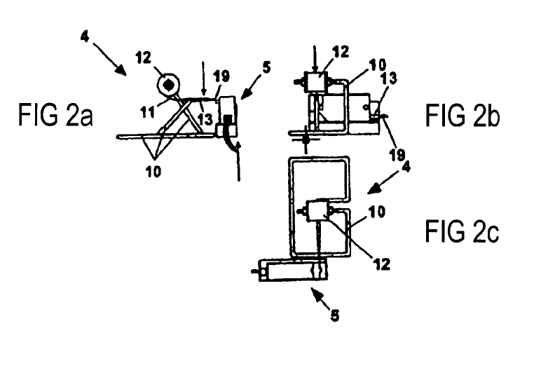

As shown in FIG. 1, a thread access unit 4 and a thread cutting unit 5 are located neighboring the robot unit 31 on the surface of the stand plate 2, which are described in greater detail with reference to FIG. 2.

Furthermore, a mounting plate 6 extends from the stand plate 2, which may be made of metal, for example, and contacts a side of an adhesive strip which is supplied by an adhesive strip unrolling unit (not shown). The mounting plate 6 is connected to a frame 25, for example, which has rolls 9, which are cushioned using a 1 cm thick plastic foam mat, for example. The mounting plate 6 preferably always has the same distance to the robot base stand 31a.

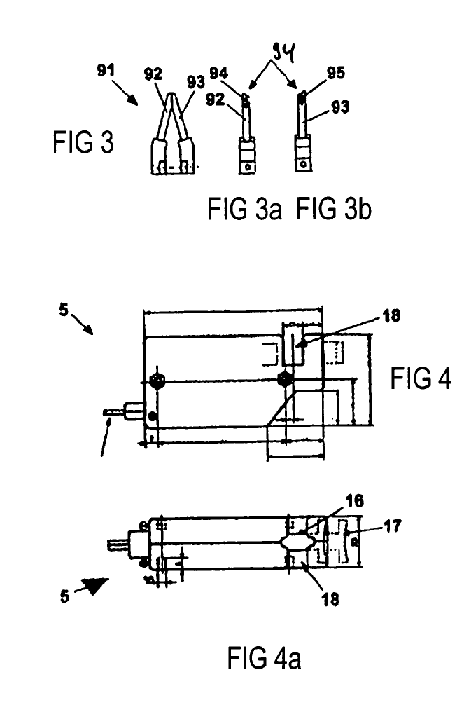

The robot unit 31 is mounted fixed on a rear area of the stand 1 and is equipped with a pneumatically operated gripper 50, which is attached to the robot flange 34a using a gripper flange connection unit. For example, pincers 91 made of aluminum, as shown in FIG. 3, are attached to the jaws of the gripper 50.

As shown in FIG. 1, the stand 1 is supported on rolling device 60 and thus movable. Alternatively, the stand 1 may be connected fixed to the floor.

FIG. 2a illustrates the thread access unit 4 and the thread cutting unit 5 from FIG. 1. The thread access unit 4 contains a thread roll 12, which is mounted on a thread holder stand 10 so it is rotatable. A thread 11 is wound in one piece on the thread roll 12. As the thread 11 is unwound, the end of the thread runs through a thread tube 13. The thread end area 19 of the thread 11 projecting out of the thread tube 13 is supplied to the thread cutting unit 5. The thread access unit 4 is positioned on the stand plate 2 of the stand 1 in such a way that the gripper 50 of the robot unit 31 may access it easily. FIG. 2b shows a front view of the thread access unit 4 and FIG. 2c shows a top view of the thread access unit 4 and the thread cutting unit 5.

FIG. 3 illustrates pincers 91 attachable to the gripper 50 for gripping a thread end area 19 of the thread end area 19, which projects out of the thread tube 13, as shown in FIG. 2, and for supplying the thread end area 19 to the thread cutting unit 5 shown in FIG. 2. FIGS. 3a and 3b show an interior view of a left pincer leg 92 and a right pincer leg 93, respectively. According to the preferred exemplary embodiment, the pincer legs 92, 93 are movable in relation to one another to be able to grip the thread end area 19. As described above, the pincers 91 are connected via a gripper flange connection unit to the robot flange 34a. The robot is capable of activating the pincer legs 92, 93 independently of one another. Furthermore, it is possible that the pincer legs 92, 93 are pre-tensioned, for example.

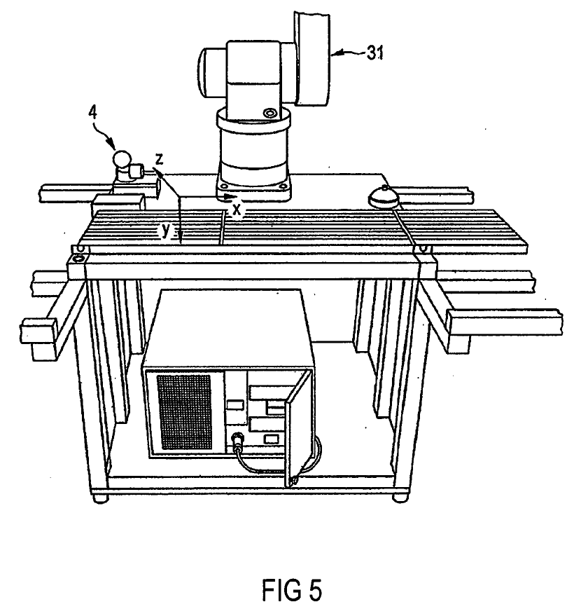

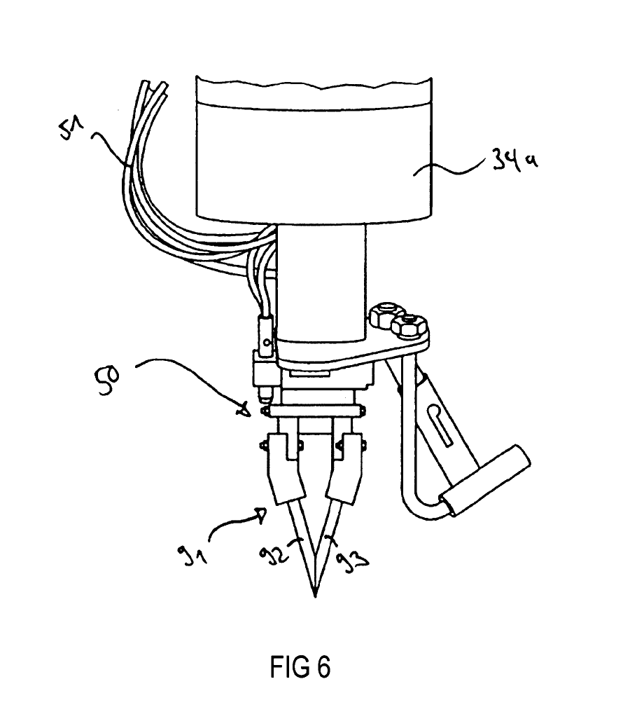

FIG. 4 shows a side view of the thread cutting unit 5 and FIG. 4a shows a top view of the thread cutting unit 5. The thread cutting unit 5 is attached to the stand 1 from FIG. 1.

As shown in FIG. 4a, a cutter 16, which is pre-tensioned by a spring, strikes an anvil 14, which is positioned diametrically opposite, by which the thread 11, which is located in a free space 18, is disrupted (cut). The cut thread (i.e., the thread piece 15), is then held by a thread clamp.

The robot unit 31 is programmed in such a way that the pincers 91 grip the thread which projects out of the thread tube 13 and guide the thread 2 cm in the horizontal direction, for example, to the free space 18 of the thread cutting unit 5. While the pincers 91 hold the thread 11, a relay is actuated using a robot controller (not shown), which first triggers cutting of the thread and then causes the clamping device of the thread cutting unit 5 to open. Next, the robot unit 31 positions the pincers 91, which still grip the thread piece 15, over the mounting plate 6 in such a way that the pincers 91 may be opened, and the thread piece 15 falls onto a desired position of an adhesive strip, whose adhesive side lies facing up on the mounting plate 6 and is supplied continuously, for example.

The procedure of gripping the thread 11, cutting the thread 11, applying the thread piece 15, and pressing the thread piece 15 onto the adhesive strip is automatically performed repeatedly by the robot unit 31, so that multiple thread pieces 15 on an adhesive strip, which is located on the mounting plate 6, may be glued onto a surface of the adhesive strip.

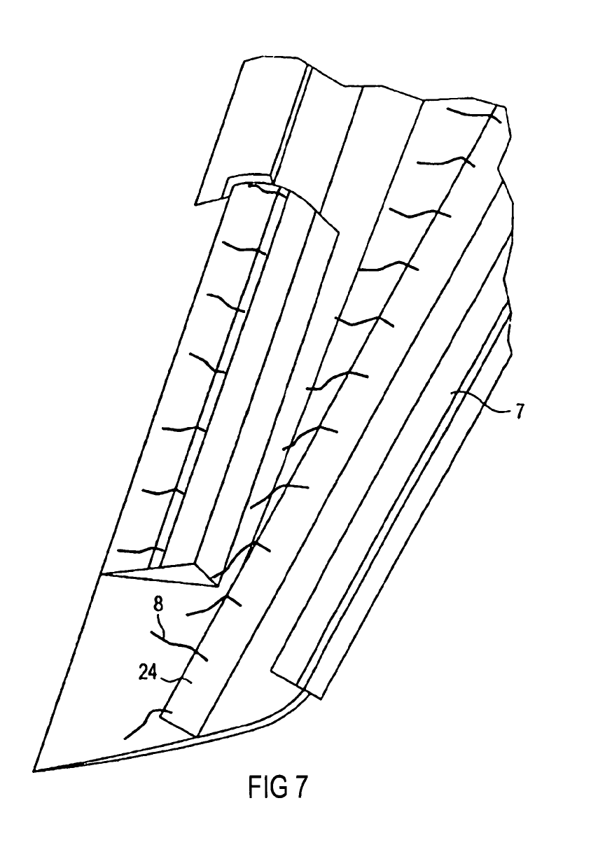

FIG. 5 shows the construction of the entire device from FIG. 1.

FIG. 6 shows an assembly unit for applying thread pieces to an adhesive strip having a gripper 50, which is attached to the robot flange 34a. Furthermore, the pincers 91 having their pincer legs 92, 93 are mounted on the gripper 50. The robot flange 34a is supplied with energy and control information via current and control cable 51 to open and close the pincer legs 92, 93 and/or rotate the gripper 50 in various directions, as shown in FIG. 1a.

FIG. 7 shows a partial view of a model wing 7, on whose surface air currents are to be examined. The thread pieces 8 are spaced uniformly, for example, and extend over equal lengths essentially perpendicularly to the longitudinal axis of the adhesive strip 24. The free ends of the thread pieces 8 project away from the adhesive strip 24 and may be engaged by an air current, the free end of the thread pieces 8 orienting in accordance with the air current, by which it is possible to visualize the air current. The thread pieces may extend at various angles and have different distances to one another.

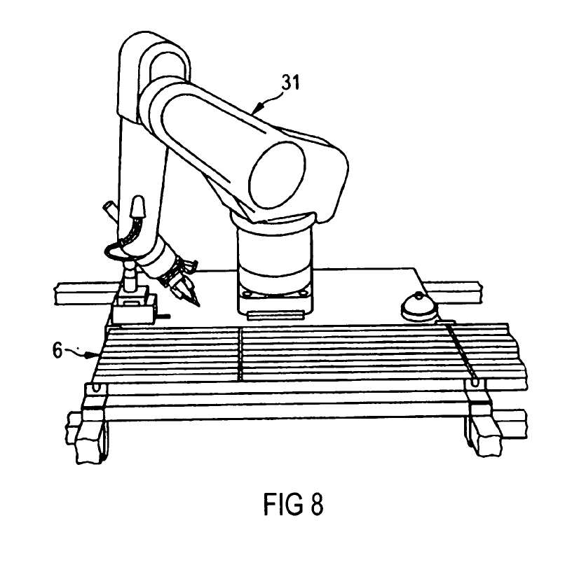

FIG. 8 shows a partial view of the mounting plate 6, which is connected fixed to the working area of the robot unit 31.

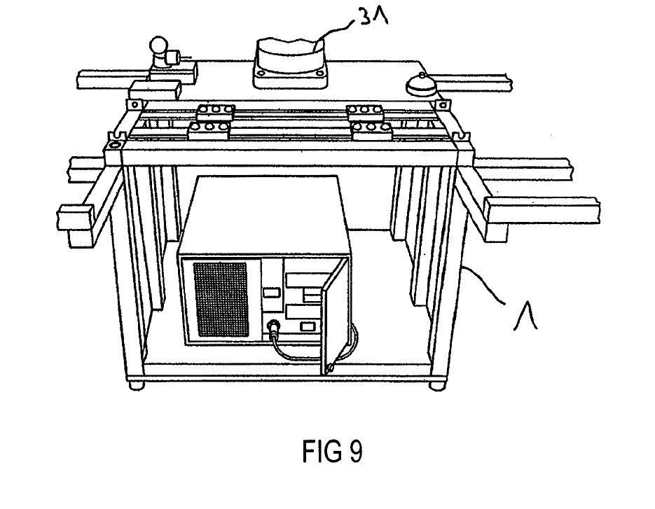

FIG. 9 shows a partial view of the stand 1, on which a robot unit 31 is mounted.

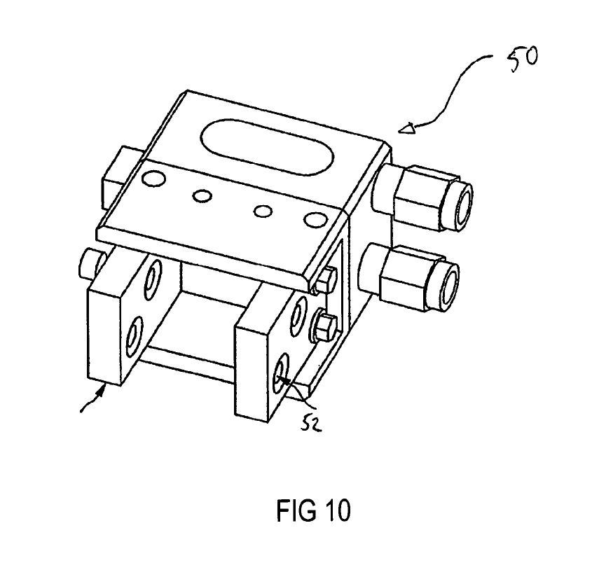

FIG. 10 shows the gripper 50 from FIG. 6, fastening areas 52 for the pincer legs 92, 93 being illustrated. The gripper 50 is attached to the robot flange 34a as described above.

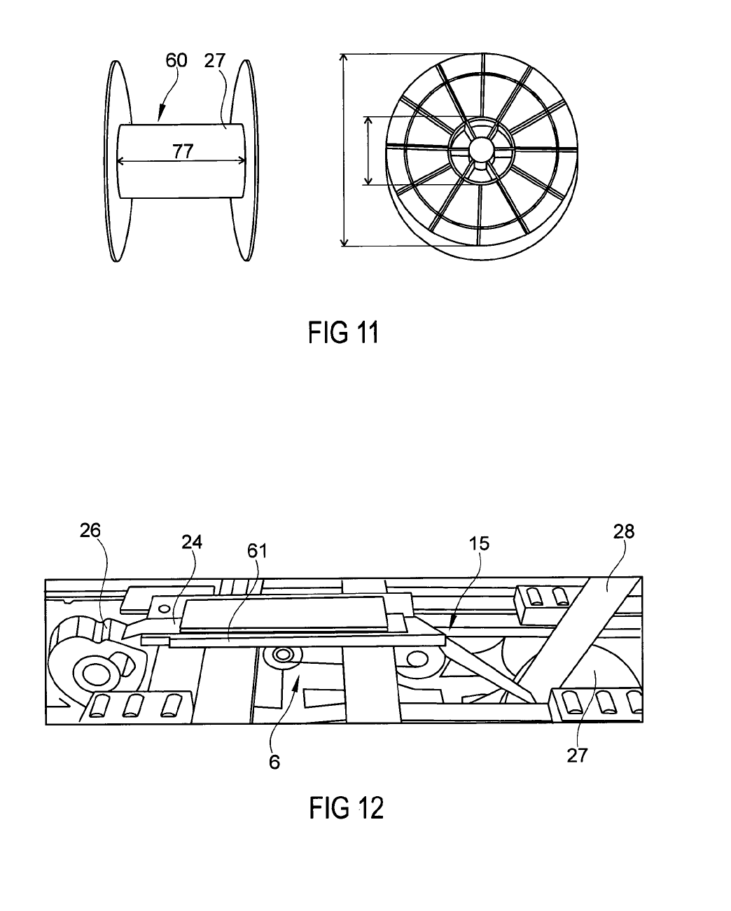

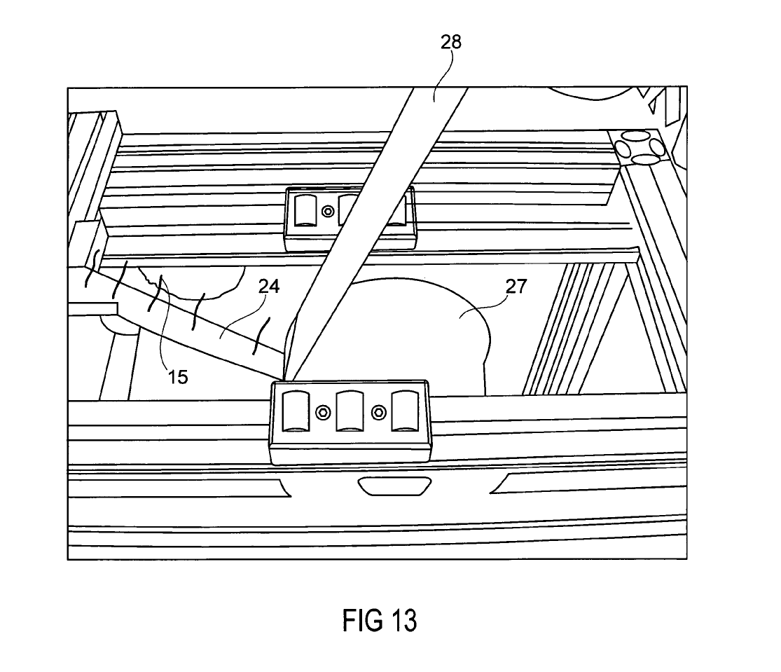

FIG. 11 shows a rolling device 60 in the form of a spool 27. The rolling device is used for rolling up the test adhesive strip (not shown), which is formed by the adhesive tape strip 24, the thread pieces 15 applied thereto, and a foam film 28 applied thereto, as shown in FIG. 12. The rolling device 60 may also have a form other than a spool to store the test adhesive strip. The test adhesive strip is wound in one piece onto the spool 27.

FIG. 12 shows a partial view of the area of the mounting plate 6 of the device from FIG. 1. The left half of FIG. 12 shows an adhesive strip unrolling unit 26, which supplies the adhesive tape strip 24 continuously in a support plate 61, which is implemented as a support plate, for example. The adhesive side of the adhesive tape strip 24 is directed upward, so that thread pieces 15 are allowed to fall from the pincers 91 of the gripper 50 which is attached to the robot flange 34a, so that the adhesive strip 24 having the thread pieces 8 shown in FIG. 7 is formed. This adhesive tape strip 24 having the thread pieces 15 applied thereto is guided to the spool 27 and wound together with the foam film 28, which is also supplied, onto the spool 27 in such a way that a test adhesive strip results, comprising the adhesive tape strip 24, the thread pieces 15 applied thereto, and the foam film 28 applied thereto. The foam film 28 is used for the purpose of protecting the individual layers rolled onto the spool 27 from sticking together, and to ensure uniform winding independently of the increasing radius. The foam film 28 may be removed easily from the adhesive tape 24 and the thread pieces 15, without damaging the thread pieces 15.

The spool 27 and the adhesive strip unrolling unit 26 are separately drivable via a motor, for example, to unroll the adhesive strip 24 from the adhesive strip unrolling unit 26 and/or to wind the adhesive strip 24 together with the thread pieces 15 applied thereon onto the spool 27. A drive of the adhesive strip unrolling unit 26 is not necessary according to another exemplary embodiment.

FIG. 13 shows a partial view of the device according to an embodiment of the present invention, in which the spool 27 is more clearly recognizable.

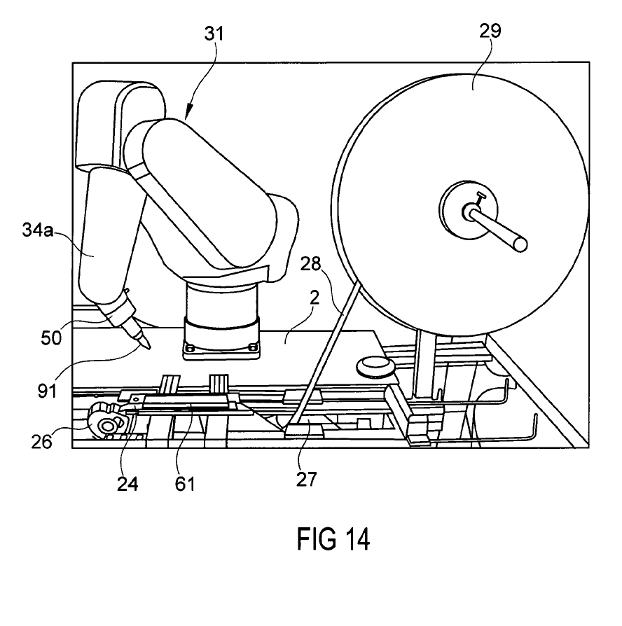

FIG. 14 shows a partial view of the device according to an embodiment of the present invention, in which a foam film unrolling unit 29 is shown.

In the following, the method for producing the test adhesive strip, as discussed above, is summarized.

The robot unit 31 is programmed in such a way that it grips the thread of the thread roll 12 hanging out of the thread tube 13 using the pincers 91 of the gripper 50, then draws the thread 11 over a length of 2 cm, for example, horizontally over the free space 18 of the thread cutting unit 5. While the pincers 91 still hold the thread 11, a relay is switched via a controller of the robot unit 31, which first triggers cutting of the thread 11 into thread pieces 15, and then opens the clamping device of the thread cutting unit 5. In the next work step, the robot unit positions the pincer 91 still grasping the thread pieces 15 over the support plate 61 in such a way that the pincers may open and eject the thread pieces 15 at an angled position to the support plate 61, having one end of the thread piece 15 contacting the adhesive tape strip 24, onto the desired position and then press it into place.

The beginning of the adhesive tape strip 24, which was drawn out of the adhesive strip unrolling unit 26, and the foam film 28, which was simultaneously drawn from an unrolling unit 29, are fixed on the spool 27 in such a way that the adhesive tape strip 24 and the foam film 28 are unrolled from their respective sources as the spool 27 rotates and rolled onto the spool 27. Simultaneously, the adhesive tape strip 24 is drawn over the working area of the small support plate 61. With the winding, the mechanism draws the adhesive tape strip 24 over the working area, so that the next thread piece 15 may be stuck on by the pincers 91 at an exactly maintained distance.

The requirement that the distance between the glued thread pieces 15 is to remain constant is implemented by a procedure, using which the steps to be set on a stepping motor (not shown) may be calculated. When deriving this procedure, for example, it is taken into consideration that the radius of the test adhesive strip (adhesive tape strip/thread pieces/foam film 24/8/28) composite wound on the spool 27 becomes larger with each rotation.

A result of the procedure described above is a spool 27 which is wound with an adhesive tape strip/thread piece/foam film 24/8/28 composite. For visualizing air currents in wind tunnel tests, for example, the required test adhesive strips of the equipped thread pieces 15 are uncoiled from the foam film 28 of finished wound spool 27 at the required length and stuck onto a model surface.

Although the present invention was described above with reference to a preferred exemplary embodiment, it is obvious that modifications and alterations may be performed without leaving the scope of protection of the present invention. For example, it is possible to apply the thread pieces to the adhesive tape 24 using varying spacing. Furthermore, as an alternative to a foam film, another suitable cover material may also be used, which may be detached easily from an adhesive surface of the adhesive tape, without damaging the thread pieces applied thereto. Furthermore, different types of thread (thread brand, thread thickness, thread color) may be used. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for producing a test adhesive strip roll, on which a test adhesive strip is wound, comprising:
a thread access unit adapted to receive a thread roll, on which a thread is wound;
a thread cutting unit adapted to cut the thread supplied from the thread roll by the thread access unit into thread pieces having a predetermined length;
an adhesive strip unrolling unit adapted to supply an adhesive strip;
an assembly unit adapted to supply the thread pieces to a surface of the adhesive strip at a predetermined angle and a predetermined distance, so that a free end of at least one of the thread pieces projects away from an edge of the adhesive strip;
an unrolling unit adapted to unroll a cover strip onto the surface of the adhesive strip and onto the thread pieces to form the test adhesive strip, containing the adhesive strip, the cover strip, and the thread pieces; and
a rolling device adapted to roll up the test adhesive strip.

2. The device of claim 1, wherein the predetermined distance between the thread pieces is substantially constant.

3. The device of claim 1, wherein the thread pieces run substantially perpendicular to a longitudinal direction of the adhesive strip on a surface and project over the edge of the adhesive strip.

4. The device of claim 1, wherein the cover strip is a foam film.

5. The device of claim 1, wherein the cover strip is removable from the adhesive strip without substantial damage the thread pieces.

6. A method for producing a test adhesive strip, comprising the steps of:
supplying a thread wound on a thread roll;
cutting the thread into thread pieces of a predetermined length;
supplying an adhesive strip;
applying the thread pieces to a surface of the adhesive strip at a predetermined angle and a predetermined distance so that a free end of a thread piece projects away from an edge of the test adhesive strip;
unrolling a cover strip onto a surface of the test adhesive strip and the thread pieces in order to form the test adhesive strip, which contains the adhesive strip, the cover strip, and the thread pieces; and
rolling up the test adhesive strip on a rolling unit to form the test adhesive strip roll.

7. The method of claim 6, wherein the steps are performed automatically.
